(19) United States
(12) Patent Application Publication
(10) Pub. No.: US 2010/0271655 A1
(43) Pub. Date: Oct. 28, 2010

(54) METHOD AND SYSTEM FOR REPLENISHING CONSUMABLES IN A PRINTING CONFIGURATION BASED ON CONFIDENCE INTERVALS

(75) Inventor: Jeremy Lee Reitz, Marion, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/428,819

(22) Filed: Apr. 23, 2009

(51) Int. Cl. G06F 15/00

(52) U.S. Cl. 358/1.15

(57) ABSTRACT

A system and method for replenishing consumables in a printing system having a plurality of multi-function devices (MFDs), including receiving information related to the plurality of MFDs; enabling at least one of the plurality of MFDs to automatically generate and transmit a notification to a storage station based on at least a portion of the information; selectively tracking one or more parameters within the information received from the plurality of MFDs; comparing the one or more parameters with one or more preset parameters stored in the storage station; and determining a confidence level interval for each of the consumables of the at least one of the plurality of MFDs that generated and transmitted the notification; wherein the consumables are automatically replenished if the confidence level interval is greater than or equal to a pre-established confidence level for at least one of the plurality of MFDs.

### BACKGROUND

1. Field of the Related Art

The present disclosure relates to printing systems, and more particularly, to a method and system for replenishing consumables in a printing configuration based on confidence intervals.

2. Background of the Related Art

A conventional printing system typically includes three components: (1) a user; (2) a server; and (3) a peripheral device. The user, via a graphical user interface, causes a print command to be transmitted to a processor of a computer system. The processor then transmits the print command to the peripheral device, such as a multifunctional device (MFD), either directly or via a server. In an office network environment, a user normally uses a desktop computer with multiple printers connected to it via the network, allowing the user to select which output devicelprinter he desires to send his print request to.

The peripheral device can then return responses to the server regarding its current state or the status of the received print jobs. The peripheral device is commonly a printer but may also be any type of MFD. In general, a MFD operates as a plurality of different imaging devices, including, but not limited to, a printer, copier, fax machine, and/or scanner or any other network type of device capable of performing a printing function.

In the area of digital printing and copying, there has been a growth in demand for MFDs which may assume the form of an arrangement in which a single print engine (e.g., xerographic or thermal ink jet print engine) is coupled with a plurality of different image input devices (or “services”). MFDs provide a broader range of functionality than traditional single-function devices, such as dedicated printers, copiers, and scanners. Due to the prevalence in the use of such MFDs and the large range of consumables involved the process; an adequate, timely, and continuous supply of such consumables such as toner, ink and print media is desired by customers. A lack of toner or ink can result in the onset of unacceptable print quality with consequential waste of resources, such as print media, while unacceptable quality printing continues.

Users appreciate knowing the amount of consumable supplies available in a printing device, especially prior to starting a print or copy job. This is particularly true in the case of a “remote” printing device in which the user is working at a host computer that is connected via some type of network to the remote printing device. Typically, a networked remote printing device may be located several hundred feet from the user, or may even be located in another building. Since the user cannot view the printing device without going to the printing device, the user is, typically, unaware of the amount or condition of the consumable supplies available to the printing device prior to sending a print job. A frequent result of this unawareness is finding that the printing device ran out of ink or toner, or paper, in the middle of a print job when the user goes to the printing device to collect the print job. Typically, this results in a waste of both time and resources as the entire print job has to be printed a second time after the printing device has be replenished with the appropriate consumable supplies.

If insufficient consumable supplies are available, the user of a printer or MFD is generally not notified of the condition until the time he/she submits the print job or in some situations not until he/she goes to the MFD to collect the job. Since such consumables periodically do need to be replenished, the user appreciates knowing the amount of supplies available prior to starting a print job, especially in the case of a “remote” printing device where the device may not be visible to the user. Thus, there is a need in the art to replenish consumables in a printing configuration in a faster and more efficient manner. Although there is prior art that alerts a user when supplies must be replenished, none of the patents in this area use confidence intervals to predict supply replenishment as described in the following sections.

Consequentially, prior art systems lack the capability to determine whether a supply alert from a MFD is a true supply alert, for the replenishment of one or more consumables related to that MFD.

### SUMMARY

The present disclosure provides a method for replenishing consumables in a printing system having a plurality of multi-function devices (MFDs). The method includes receiving information related to the plurality of MFDs; enabling at least one of the plurality of MFDs to automatically generate and transmit a notification to a storage station based on at least a portion of the information; selectively tracking one or more parameters within the information received from the plurality of MFDs; and comparing the one or more parameters with one or more preset parameters stored in the storage station. The method further includes determining a confidence interval for each of the consumables of the at least one of the plurality of MFDs that generated and transmitted the notification; wherein the consumables are automatically replenished if the confidence level interval is greater than or equal to a pre-established confidence level for at least one of the plurality of MFDs.

The present disclosure also provides a printing system suitable for use with a plurality of multi-function devices (MFDs), that includes a storage station for storing information related to the plurality of MFDs; wherein the plurality of MFDs are enabled to automatically generate and transmit a notification to the storage station based on at least a portion of the information so as to selectively manipulate one or more parameters within the information received from the plurality of MFDs and compare the one or more parameters with one or more preset parameters stored in the storage station for determining a confidence level interval for each of the consumables of the at least one of the plurality of MFDs that generated and transmitted the notification; and wherein the consumables are automatically replenished if the confidence level interval is greater than or equal to a pre-established confidence level for at least one of the plurality of MFDs.

The present disclosure also provides a computer-readable medium storing programmable instructions configured for being executed by at least one processor for replenishing consumables in a printing system having a plurality of MFDs performing the methods described herein in accordance with the present disclosure. The computer-readable medium can include flash memory, CD-ROM, a hard drive, etc.

### BRIEF DESCRIPTION OF THE DRAWINGS

Various embodiments of the present disclosure will be described herein below with reference to the figures wherein:

FIG. 1 is a block diagram depicting a printing system having a plurality of multi-function devices, where the printing system provides for the replenishment of consumables by using confidence intervals, in accordance with the present disclosure;

FIG. 2 is a flow chart illustrating a printing system providing for the replenishment of consumables by using confidence intervals, in accordance with the present disclosure; and

FIG. 3 is a flow chart illustrating how an alert is generated based on a volume of a last order of a consumable, in accordance with the present disclosure.

### DETAILED DESCRIPTION

The present disclosure relates to printing systems, and more particularly, to a method and system for replenishing consumables in a printing configuration. The present disclosure further presents a printer and communications circuitry for connecting to at least one network and establishing at least one network connection.

The present disclosure also tracks all supplies ordered against any given device, the number of days between orders, and the volume between these order points. Using this information to determine a past ordering pattern, the present disclosure can determine whether any given alert actually requires action or is the result of a device or process issue. Thus, using confidence intervals, the rate of alerts being generated from the device can be rated and it can be determined whether the alerts coincide with the confidence interval level for that device. The notification may be a consumables replenishment alert that is based on a power saving condition. However, the consumables replenishment alert may be based on a threshold level preset for each of the plurality of MFDs. In other words, each MFD may have a different threshold level based on a variety of factors, such as print volume, color printing volume, etc.

The present disclosure further relates to the reliability of a replaceable element in a printing system. The present disclosure also relates to the life remaining for a replaceable element so that timely replacement may be made without unduly increasing operation costs resulting from too early a replacement or, in the alternative, a consumables failure from waiting too long to replace. One concept is to replace consumables before they fail so as to avoid unnecessary machine down time and loss of productivity. Another concept relates to a method for assessing end of life determinations for high frequency service items in a document processing system.

Additionally, many businesses, including retail organizations, retail stores, wholesale distributors, manufacturing companies, and the like, perform periodic and ongoing strategic analysis as well as forecasting and automatic replenishment of their various business inventories and supplies in order to improve the efficiency and service levels of their operations. Such strategic forecasting and automatic replenishment systems, as described in the exemplary embodiments of the present disclosure, help to manage inventories and supplies by predicting future throughputs, by quantifying anticipated depletion of raw and finished materials associated with those throughputs, and by quantifying the orders necessary to replenish depleted stocks.

The strategic analysis, forecasting and automatic replenishment functions that these systems, as described by the exemplary embodiments of the present disclosure, may perform can include: (1) predicting quantities and profit margins for usage over a specific period of time; (2) predicting the quantities of parts and upstream consumables that may be required to meet anticipated demand; (3) forecasting the lead time to supply materials necessary to meet anticipated demand; and (4) predicting the specific demand periods when certain products will be needed. When these automated systems or processes are optimized, businesses may be better positioned to improve profits, increase efficiencies, and reduce waste.

Moreover, a goal of the exemplary embodiments of the present disclosure is to provide forecast and replenishment systems that provide for the automatic replenishment of goods/consumables in the right volume and at the right time with minimal human intervention in order to help optimize the profitability and efficiency of business operations. The consumables may be replenished in a manual or automatic manner if a confidence level interval is greater than or equal to a predetermined threshold confidence level that is established for each of the MFDs. These confidence intervals may be established by the user of the MFDs or may be preset by the manufacturer or by any other third party. The confidence intervals may be preset at any desirable level based on user preference and/or user requirements. A confidence level may be established for each consumable of each MFD. In other words, each MFD may have more than one confidence level set for each consumable and each consumable of the same MFD may have different settings for different consumables. For instance, for one MFD, the ink level may be set at a different confidence level than the toner level.

As used herein, “print” is defined as sending a document to the printer through any one of a multitude of ways. Moreover, “printer” can refer to any device that accepts text and graphic output from any type of computing device and transfers the information to any printable medium. A “printer” can refer to any type of xerographic, solid ink, liquid ink, cut sheet or web-based device used to print onto a wide array of printable media. The term “printer” encompasses any apparatus, such as a digital copier, bookmaking machine, facsimile machine, multi-function machine, etc. which performs a print outputting function for any purpose.

The term “MFD” can refer to any device/machine that connects to either a computing device and/or network and performs two or more of the following functions: print, scan, copy, and/or fax. Digital copiers, fax machines, printers, and scanner combinations are all examples of MFDs. The term “MFD” can further refer to any hardware that combines several functions in one unit. For instance, an MFD can be a standalone printer or any type of standalone machine/device/apparatus/component. For example, an MFD can be one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics can apply in any type of entertainment, communications, home, and/or office capacity. Thus, the term “MFDs” can refer to any type of electronics suitable for use with a circuit board and intended to be used by a plurality of individuals for a variety of purposes.

The term “storage station” can refer to data storage. “Data storage” can refer to any article or material (e.g., a hard disk) from which information is capable of being reproduced, with or without the aid of any other article or device. “Data storage” can refer to the holding of data in an electromagnetic form for access by a computer processor. Primary storage is data in random access memory (RAM) and other “built-in” devices. Secondary storage is data on hard disk, tapes, and other external devices. “Data storage” can also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “consumables” can refer to ink, toner, or any other type of supply related to an MFD. “Consumables” can refer to something that is capable of being consumed, destroyed, dissipated, wasted, or spent by the apparatus. “Consumables” can also refer to products that consumers buy recurrently or items which get used up or discarded. “Consumable supplies” are such products as ink cartridges, toner cartridges, or any other type of supply related to a printer or MFD and do not include capital goods such as computers, fax machines, and other business machines or office furniture. “Consumable supplies” may be consumed through ordinary use of the apparatus; where the rate of consumption can be measured and is predictable based on the amount of use of the apparatus.

The term “notification” can refer to a visual or audible indication alerting the user of various status conditions relating to the MFD or device. “Notification” is the act of notifying someone of something or making a formal announcement. “Notification” can also refer to the warning or announcing of something, usually done in advance.

The term “confidence level interval” can refer to a probability that an event has occurred. In accordance with that probability, a response is transmitted to show that the event has occurred. For example, the current confidence level interval is calculated/computed/processed for each consumable using the captured information based on the volume since the last order and the days since the last order. The confidence level interval may be applied to rate the quality of device status and alerts for proactive management of supplies on managed service contracts.

In addition, the exemplary embodiments of the present disclosure also propose that the user of the printing system pay a fee to the service provider (e.g., leaser of the multi-function machine) for the latter, either directly via the computer system or a server inoperative communication with the printing system, providing automatic replenishment of consumable printing supplies for their printing needs associated with the printer. The notification is transferred to the remote server, operated by the service provider. Once the information has been received, the service provider may automatically replenish the consumable or alert the user of the need for replenishment. The printing system, connected to the at least one network, receives information relating to the plurality of MFDs, which is then managed by a supply control module. The at least one of the plurality of MFDs is enabled to automatically generate and transmit a notification to a storage station as described below. Embodiments will be described below while referencing the accompanying figures. The accompanying figures are merely examples and are not intended to limit the scope of the present disclosure.

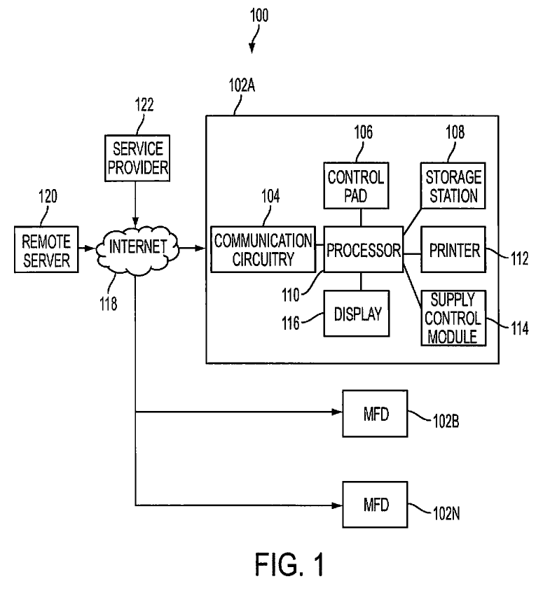

With reference to FIG. 1, there is depicted a block diagram of a printing system having a plurality of MFDs, where the printing system provides for the replenishment of consumables by using confidence intervals, in accordance with the present disclosure.

The block diagram depicts a supply replenishment system 100 having a plurality of MFDs 102A-n. MFD 102A includes communications circuitry 104; a control pad 106; a storage station 108; at least one processor 110; a printer 112; a supply control module 114; and a display 116. Upon receipt of user input via the control pad 106, the processor 110 receives an instruction for performing a particular function of MFD 102A.

The MFDs are of the type capable of scanning, copying, and electronically transmitting documents and can also be xerographic MFDs. A service provider 122 may utilize the system 100 for determining, from a remote system 120, whether consumables need to be re-ordered for a particular multi-function device, such as MFD 102A. The remote system 120 routes the information through at least one network 118, via at least one network connection, such as the Internet, WAN, LAN, etc., to MFD 102A or MFDs 102A-102n.

The remote system 120 may include a modem, network interface card, or any other device capable of transmitting and receiving signals over the network 118. Network 118 may include any type of interconnected communication system, and may implement any communications protocol, which may be secured by any security protocol.

Remote server 120 may further include a plurality of processors and a memory device for executing program instructions, as well as network interfaces. Remote server 120 may also comprise a collection of servers, rather than a single server. In one particular embodiment, remote server 120 may include a combination of enterprise servers such as an application server and a plurality of database servers.

Additionally, the memory device may include volatile and nonvolatile data storage, including one or more electrical, magnetic or optical memories such as a RAM, cache, hard drive, CD-ROM drive, tape drive or removable storage disk. The components of a user computing device may be connected via an electrical bus or wirelessly.

The service provider 122 may be an entity or business desiring to determine the confidence level interval for each consumable on a particular multi-function device in order to determine whether a supply alert from a device is a true alert. It is contemplated that the user of the MFD 102A and the service provider 122 will have a contractual agreement, allowing communications to occur between the service provider 122 and the user of the MFD 102A. It is further contemplated that the contractual agreement may provide for the payment of a fee from the operator of the MFD 102A to the service provider 122 of the printing system 100 for using the system 100 to determine need for replenishment and actual replacement of one or more consumables. The contractual agreement may also include terms which specify that the owner/operator/controlling entity is entitled to receive consumable printing supplies for their printing needs associated with the printer.

The service provider may be an Independent Service Organization (ISO). An ISO can be entity that develops, offers, controls, manages, owns, alters and/or sells software and/or hardware products. An ISO can be any entity that performs one or more tasks on one or more pre-existing MFDs, which may or may not be controlled or owned by the ISO. For example, the entity can offer a service with an existing software package and/or with any type of existing Internet-based service. In other words, an ISO need not own or provide the MFDs. The MFDs may be owned or provided by any third party not related or associated with the ISO. In the present disclosure, it is contemplated that the entity (such as an ISO) can offer any type of service and/or products. The term “entity” can refer to anything that may exist as a discrete and/or distinct unit that owns, operates, manages, and/or controls one or more of a plurality of machines (such as MFDs). For example, the term “entity” may include the term “company.”

The printing system 100 further includes at least one MFD 102a, 102b, etc. in communication with the remote server 120. Although there is only a single remote server 120 depicted in FIG. 1, it is envisioned that there may be a plurality of remote servers. A function that may be performed under the control of the processor 110 includes the printer 112 to print a document. It is contemplated that the user can instruct the processor 110 to instruct the printer 112 that the printing system 100 will automatically determine whether the consumables need to be re-ordered on a particular MFD 102A. It is also contemplated that once the supply control module 114 determines whether the alert is correct, the consumables replenishment alert or notification will be sent to the remote system 120. If the alert is an actual replenishment alert and coincides with the pre-configured confidence level pre-established for the MFD 102A, the consumables will be automatically replenished. On the other hand, if the replenishment alert is based on a power saving condition or duplicate alert, the consumable will not be replenished. Additionally, the consumables are replenished for each MFD that sends a notification to a storage station. If no notification has been sent by a particular MFD, no action is taken regarding that MFD.

In other words, if a plurality of notifications are transmitted from one of the plurality of MFDs concerning a single consumable, the confidence level interval disqualifies all but one notification of the plurality of notifications. Moreover, if a plurality of notifications are transmitted from one of the plurality of MFDs concerning two or more consumables, the confidence level interval accepts all notifications of the plurality of notifications.

For example, a single MFD may send more than one notification regarding the same consumable. This may occur because a user reset the MFD and the MFD has not realized that it sent the same notification twice. The system adjusts for such errors by accepting only one notification regarding each consumable, without the possibility that multiple consumables are sent for one notification. However, the system also distinguishes the scenario when more than one notification has been sent by the same MFD for different consumables. In this case, the system accepts each notification from each consumable from the same MFD. Therefore, the system can replenish consumables related to one or more MFDs in an efficient manner without sending duplicate or triplicate consumables based on false alerts.

The at least one processor 110 of the MFD 102A is in operable communication with the storage station 108, printer 112, the supply control module 114, the display 116 and the control pad 106. It is also in operable communication with the communication circuitry 104 in order to enable the MFD 102A to generate and transmit messages to and from remote server 120 via network 118. Other functions that can be performed under the control of the processor 110 include instructing the display 118 to alert the user of the re-order alert and other critical printing status information. Further, other functions that can be initiated by a user and performed under the control of the processor 110 include: requesting electronic transmission and selecting the option to re-order a replenishment of the particular consumable of the MFD 102A.

The supply control module 114 includes programmable instructions for receiving relevant information related to MFD 102A including: the current toner levels on the device, the actual replenishment point of the supply in the device, the number of days between supply orders against any given device, and the volume ordered between these order points. The supply control module 114 further includes programmable instructions for automatic replenishment of consumables, after confirming that the re-order alert is correct using the calculated confidence level interval. By using confidence intervals, the alerts generated from MFD 102A are rated, based on a threshold level preset for each MFD 102A-n.

The supply control module 114 further includes instructions for calculating whether the alerts coincide with the confidence interval and actuating a visual indication when the confidence level is reached. Also, if a plurality of notifications transmitted from MFD 102A concerns a single consumable, the confidence level interval may disqualify all but one notification. On the other hand, if the plurality of notifications concern two or more consumables, the confidence level interval may accept all notifications. This is an exemplary embodiment. One skilled in the art can contemplate many different configurations.

The set of programmable instructions of the supply control module 114 can be application software stored within a memory, such as RAM and ROM, of the at least one processor 110, and or a computer-readable medium, such as a hard drive, CD-ROM, flash memory, etc., readable by one or more reading devices of the MFD. Further, although the module is depicted as being separate from the processor, it could be considered part of the processor itself and also composed of more than one module.

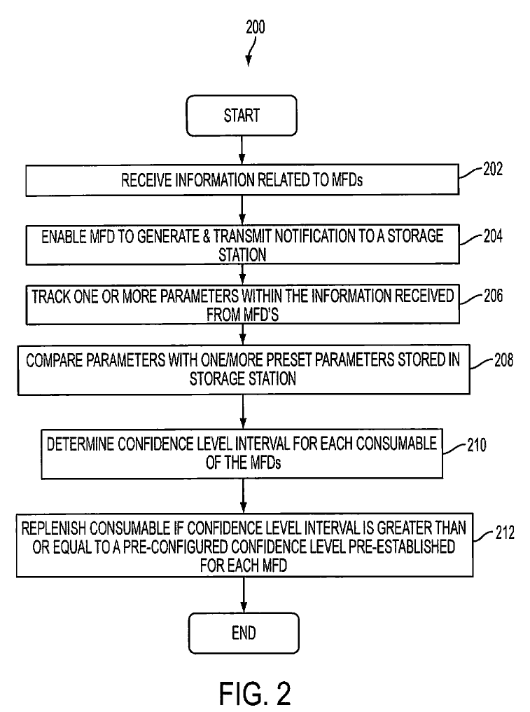

With reference to FIG. 2, there is illustrated a flow chart describing a printing system providing for the replenishment of consumables by using confidence intervals, in accordance with the present disclosure. In initial step 202, information related to a particular MFD is received. Then, in step 204 of method 200, the MFD is enabled to generate and transmit notification to the storage station. In step 206, one or more parameters are tracked within the information received from MFDs.

Further, one or more parameters are compared with one or more preset parameters stored in the storage station in step 208. Then, the device alerts being generated by a particular device are rated, based on a pre-determined parameter for the particular device. The Confidence Level Interval of the particular MFD is then determined for each consumable in Step 210. The one or more parameters used may include: order history, number of days between orders of the order history, and a volume between the orders. Finally, in step 212, if the confidence level interval is greater than or equal to a pre-configured and pre-established confidence level, the consumable is replenished. The process then ends.

In accordance with the steps presented in FIG. 2, and especially steps 206 and 208 related to the “parameters,” one example of a parameter is provided. For instance, a toner usage manager may calculate the number of sheets or pages of printed images (i.e., text, graphics etc.) which can be produced by the print engine given the amount of toner remaining in reservoir and available to the print engine. The toner usage manager receives toner remaining values providing the amount of toner remaining in toner reservoir detected by toner sensor. The toner usage manager uses the toner usage over the printer lifetime to calculate an average amount of toner required per page. The amount of toner remaining in the toner reservoir and the average amount of toner required per printed page is then used to calculate the number of pages which can be printed with the amount of toner available to the print engine. One or more standard deviations on the calculated average amount of toner required may be added to the average amount of toner required to increase the accuracy of the result and provide a greater probability that the “confidence interval” is accurate.

One skilled in the art can envision a plurality of different parameters to be used to determine when replenishment is required based on a plurality of different confidence intervals.

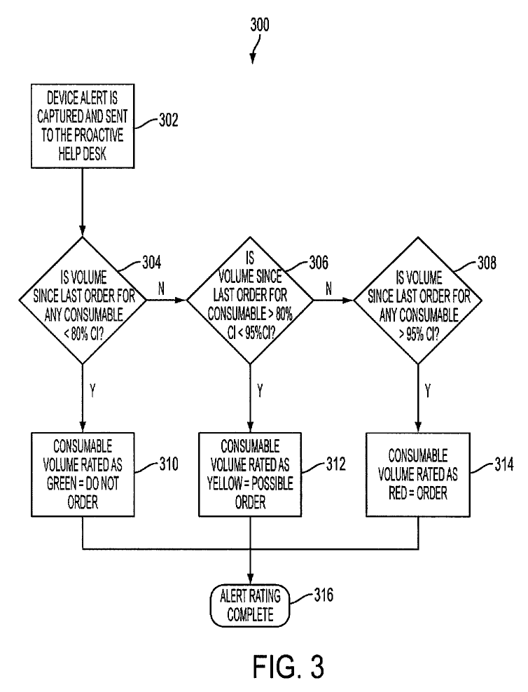

FIG. 3 is a flow chart illustrating how an alert is generated based on a volume of a last order of a consumable, in accordance with the present disclosure. More specifically, FIG. 3 illustrates the device alert being captured and rated for the particular consumable of the particular MFD. As seen in FIG. 3, the incoming alert is compared to the prior histories of the particular MFD (e.g., volume, time, prior data, etc. . . . ).

With reference to FIG. 3, the alert system 300 includes the following steps. In step 302, the device alert is captured and sent to a help desk. In step 304, a decision is made whether the volume since the last order for any consumable was less than 80%. If the answer is YES, the process flows to step 310. If the answer is NO, the process flows to step 306. In step 306, a decision is made whether the volume since the last order is between 80% and 95%. If the answer is YES, the process flows to step 312. If the answer is NO, the process flows to step 308. In step 308, a decision is made whether the volume since the last order for any consumable was greater than 95%. If the answer is YES, the process flows to step 314. In step 310, the consumable volume is rated as “Green,” which indicates that a re-order is not necessary. In step 312, the consumable volume is rated as “Yellow,” which indicates that a re-order is available or possible based on contractual agreements. In step 314, the consumable volume is rated as “Red,” which indicates that a re-order is necessary since a majority of the consumables have been depleted. In step 316, the alert rating is complete.

As depicted in FIG. 3, if the volume since the last order for any consumable is less than 80%, the consumable is rated as “Green” and the consumable is not replenished. If the volume since the last order for any consumable is less than 95% but greater than 80%, the consumable is rated as “Yellow” and it is considered a “possible order.” Finally, if the volume since the last order for any consumable is greater than 95%, the consumable is rated as “Red” and the consumable is automatically ordered and replenished. Accordingly, a visual indication is actuated when the confidence level interval is reached.

The exemplary embodiments described with reference to FIG. 3 permit the sufficiency of collected data to be automatically determined on a production-event-by-production-event basis. In particular, upon collecting a dataset, performance measure related values can be readily calculated and used to determine whether further collection of production related data is required. In one example, as illustrated in FIG. 3, a mean and confidence interval are used to obtain a confidence ratio. By comparing the confidence ratio to a pre-selected threshold value (e.g., 80% or 95%), automatic determination can be readily obtained.

Additionally, each variable or parameter monitored represents a “confidence interval.” The above-mentioned process is repeated periodically for predetermined time periods, and the “confidence intervals” are repeatedly calculated each time a variable or parameter is updated based on toner usage. It will be appreciated that different variables and/or parameters may produce different “confidence intervals.” The variables and/or parameters may be order history data, previous timing data relating to deliveries, volume of printing, color printing, etc.

Moreover, the prediction may be made based on various factors, such as: (1) the number of days since the previous replenishment, (2) the average amount of paper dispensed by each MFD every day, and (3) each MFDs paper dispensing patterns, such as daily variations, variations over certain, cycles and/or variations over seasons. The amount of paper dispensed at each MFD can be tracked historically. The amounts dispensed will vary from day to day, but the variance will be expected to lie within known limits.

Optionally, a confidence level may be submitted by a user or system administrator by manually specifying one or more standard deviations regarding the one or more variables and/or parameters.

Furthermore, methods consistent with embodiments of the present disclosure may conveniently be implemented using program modules, hardware modules, or a combination of program and hardware modules. Such modules, when executed, may perform the steps and features disclosed herein, including those disclosed with reference to the exemplary flow chart shown in FIG. 2. The operations, stages, and procedures described above and illustrated in the accompanying drawings are sufficiently disclosed to permit one of ordinary skill in the art to practice the present disclosure. Moreover, there are many computers and operating systems that may be used in practicing embodiments of the present disclosure and, therefore, no detailed computer program could be provided that would be applicable to these many different systems. Each user of a particular computer is aware of the language, hardware, and tools that which are most useful for that user's needs and purposes.

The above-noted features and aspects of the present disclosure may be implemented in various environments. Such environments and related applications may be specially constructed for performing the various processes and operations of the present disclosure, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the present disclosure, or it may be more convenient to construct a specialized apparatus or system to perform the required methods and techniques.

Moreover, in accordance with the exemplary embodiments, customers are able to reduce or recover the cost of printing with minimal effort to set up and administer a system. Customers will be able to measure the true costs of printing on all the MFDs connected to or attempting to connect to the system. Customers will also be able to implement print policies and/or rules for cost reduction and charge-out at the point of print decision-making. Customers will also be able to easily set up the system and configure the system to their desired specifications since the system automatically discovers when a consumable needs to be replenished. Customers will further be able to measure, understand, and gain control over the costs and environmental impact of printing in the organization by analyzing print volumes and usage by department, organization, and/or location when replenishment of consumables is ordered.

The present disclosure also includes as an additional embodiment a computer-readable medium which stores programmable instructions configured for being executed by at least one processor for performing the methods described herein according to the present disclosure. The computer-readable medium can include flash memory, CD-ROM, a hard drive, etc.

Embodiments of the present disclosure may be implemented as computer-readable media that include program instructions or program code for performing various computer-implemented operations. The program instructions may be those specially designed and constructed for the purposes of the present disclosure, or they may be of the kind well known and available to those having skill in the computer software arts. Examples of program instructions include, for example, machine code, such as produced by a compiler, and files containing a high-level code that can be executed by the computer using an interpreter.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for replenishing consumables in a printing system having a plurality of multi-function devices (MFDs), the method comprising:
receiving information related to the plurality of MFDs;
storing a notification both based on at least a portion of the information and transmitted from at least one of the plurality of MFDs;
selectively tracking one or more parameters within the information received from the plurality of MFDs;
comparing the one or more parameters selectively tracked with one or more preset parameters; and
determining a confidence level interval based on the comparison for each of the consumables of the at least one of the plurality of MFDs from which the notification was transmitted;
wherein the consumables are automatically replenished if the confidence level interval is greater than or equal to a pre-established confidence level for the at least one of the plurality of MFDs from which the notification was transmitted.

2. The method according to claim 1, wherein the one or more parameters includes one of the following: order history, number of days between orders of the order history, and a volume between the orders.

3. The method according to claim 1, wherein the notification is a consumables replenishment alert.

4. The method according to claim 3, wherein the consumables replenishment alert is based on a power saving condition.

5. The method according to claim 3, wherein the consumables replenishment alert is based on a threshold level preset for each of the plurality of MFDs.

6. The method according to claim 1, wherein if a plurality of notifications are transmitted from one of the plurality of MFDs concerning a single consumable, the confidence level interval disqualifies all but one notification of the plurality of notifications.

7. The method according to claim 1, wherein if a plurality of notifications are transmitted from one of the plurality of MFDs concerning two or more consumables, the confidence level interval accepts all notifications of the plurality of notifications.

8. The method according to claim 1, wherein a visual indication is actuated when the confidence level interval is reached for each of the plurality of MFDs.

9. A printing system comprising:
a plurality of multi-function devices; and
a storage station for storing information related to the plurality of MFDs;
wherein the plurality of MFDs store a notification both based on at least a portion of the information and transmitted from at least one of the plurality of MFDs so as to selectively manipulate one or more parameters within the information received from the plurality of MFDs and compare the one or more parameters selectively manipulated with one or more preset parameters for determining a confidence level interval based on the comparison for each of the consumables of the at least one of the plurality of MFDs from which the notification was transmitted; and
wherein the consumables are automatically replenished if the confidence level interval is greater than or equal to a pre-established confidence level for at least one of the plurality of MFDs.

10. The system according to claim 9, wherein the one or more parameters includes one of the following: order history, number of days between orders of the order history, and a volume between the orders.

11. The system according to claim 9, wherein the notification is a consumables replenishment alert.

12. The system according to claim 11, wherein the consumables replenishment alert is based on a power saving condition.

13. The system according to claim 11, wherein the consumables replenishment alert is based on a threshold level preset for each of the plurality of MFDs.

14. The system according to claim 9, wherein if a plurality of notifications are transmitted from one of the plurality of MFDs concerning a single consumable, the confidence level interval disqualifies all but one notification of the plurality of notifications.

15. The system according to claim 9, wherein if a plurality of notifications are transmitted from one of the plurality of MFDs concerning two or more consumables, the confidence level interval accepts all notifications of the plurality of notifications.

16. The system according to claim 9, wherein a visual indication is actuated when the confidence level interval is reached for each of the plurality of MFDs.

17. A computer-readable medium storing programmable instructions configured for being executed by at least one processor for replenishing consumables in a printing system having a plurality of multi-function devices (MFDs), the method comprising: receiving information related to the plurality of MFDs;
storing a notification both based on at least a portion of the information and transmitted from at least one of the plurality of MFDs;
selectively tracking one or more parameters within the information received from the plurality of MFDs;
comparing the one or more parameters selectively tracked with one or more preset parameters; and
determining a confidence level interval based on the comparison for each of the consumables of the at least one of the plurality of MFDs from which the notification was transmitted;
wherein the consumables are automatically replenished if the confidence level interval is greater than or equal to a pre-established confidence level for the at least one of the plurality of MFDs from which the notification was transmitted.

18. The computer-readable medium according to claim 17, wherein the one or more parameters includes one of the following: order history, number of days between orders of the order history, and a volume between the orders.

19. The computer-readable medium according to claim 17, wherein the notification is a consumables replenishment alert.

20. The computer-readable medium according to claim 19, wherein the consumables replenishment alert is based on a power saving condition.

21. The computer-readable medium according to claim 19, wherein the consumables replenishment alert is based on a threshold level preset for each of the plurality of MFDs.

22. The computer-readable medium according to claim 17, wherein if a plurality of notifications are transmitted from one of the plurality of MFDs concerning a single consumable, the confidence level interval disqualifies all but one notification of the plurality of notifications.

23. The computer-readable medium according to claim 17, wherein if a plurality of notifications are transmitted from one of the plurality of MFDs concerning two or more consumables, the confidence level interval accepts all notifications of the plurality of notifications.

24. The computer-readable medium according to claim 17, wherein a visual indication is actuated when the confidence level interval is reached for each of the plurality of MFDs.
